(19) United States
(12) Patent Application Publication
(10) Pub. No.: US 2007/0212660 A1
(43) Pub. Date: Sep. 13, 2007

(54) HEATED DENTAL PLACEMENT AND CARVING INSTRUMENT

(76) Inventors: Frederick A. Rueggeberg, Augusta, GA (US); Donald Mettenburg, Evans, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 11/676,838

(22) Filed: Feb. 20, 2007

Related U.S. Application Data
(60) Provisional application No. 60/775,189, filed on Feb. 21, 2006.

(51) Int. Cl. A61C 3/00; A61C 19/00

(52) U.S. Cl. 433/32; 433/141

(57) ABSTRACT

A dental instrument for working with composite resin includes an elongate handle and at least one tool attached at an end of the elongate handle. The tool is heated and/or vibrationally driven, and used to engage and work dental composite resin.

### CROSS-REFERENCE TO RELATED APPLICATION

This application claims the benefit of U.S. Provisional Patent Application Ser. No. 60/775,189, filed Feb. 21, 2006, which application is incorporated herein by reference in its entirety for all purposes.

### TECHNICAL FIELD

The present invention relates generally to the field of dental placement and carving instruments, and more particularly, to dental instruments having a heated tip for working with restorative materials.

### BACKGROUND OF THE INVENTION

In the field of dentistry, dental restoration work is utilized for cavity preparation and aesthetic tooth restorations. Typically, this type of work is performed by placing a light curable composite resin onto a tooth needing repair and curing the resin by exposing the resin to light in the blue spectrum. The process of restoring a tooth generally encompasses placing the resin on the tooth in increments of about 2 mm until the tooth is deemed to be the appropriate size. Subsequently, the last incremental placement of restorative resin must then be shaped and adapted to match the natural contours of the original tooth (or a natural tooth in the case of aesthetic restorations). In order to shape and adapt the tooth, a dentist typically uses placement and carving instruments as seen in FIG. 1.

Currently, it has been found that it is very difficult to accurately place and shape restorative resin with known instruments. This problem is further exacerbated when the dentist must apply additional resin to uncured resin already placed on the tooth, as the resin is very viscous and “sticky”. For instance, when a dentist applies the second increment of resin to a tooth, the second increment often moves the first increment. The dentist then has to rework the first increment of resin. Additionally, it has been found that because of the high viscosity of the resin, the final shaping and naturalization process is very difficult to accomplish because it is very arduous to finely adapt and shape a minute amount of resin.

To combat these problems, dentists have proposed numerous solutions, including instruments that are less sticky, chemicals that render known restorative tools less sticky, and heating the restorative material before applying the material to a tooth to lower the resin's viscosity. However, none of these proposed solutions have solved the present problem. Therefore, it can be seen that needs exist for dental instruments that allow a dentist to both place and finely shape restorative materials. It is to the provision of a dental instrument meeting these needs and others that the present invention is primarily directed.

### SUMMARY OF THE INVENTION

The present invention provides for a dental instrument that is used in the carving and sculpting of dental composite resin. The dental instrument utilizes heated ends to lower the viscosity of the composite resin. By lowering the viscosity of the resin, a dentist is more easily able to place, modify, adapt and sculpt the resin.

In one aspect, the present invention is a dental instrument for working with composite resin including an elongate handle and a tool located at a first end of the elongate handle. The tool is heated and adapted to manipulate dental composite resin. Optionally, the tool also includes a heating element embedded within the tool to heat the tool's surface.

In another aspect, the invention is a double-sided dental carving instrument for modifying light curable composite resin having an elongate handle, a first carving tool coupled to a first end of the handle, and a second carving tool coupled to a second end of the handle. The dental carving instrument also includes a power supply positioned within the handle and at least one heating element electrically coupled to the power supply for heating the first carving tool. Optionally, the instrument includes a second heating element coupled to the power supply for heating the second carving tool. Additionally, the instrument can optionally include a vibrator electrically coupled to the power supply for vibrating at least the second carving tool.

In still another aspect, the invention is a dental instrument including an elongate handle defining a cavity therein, wherein the handle includes first and second ends. The instrument also includes a power supply housed within the cavity of the elongate handle, a first carving tool coupled to the first end of the elongate handle, a second carving tool coupled to the second end of the handle, a heating element electrically coupled to the power supply and embedded within the first carving tool, and a vibrator electrically coupled to the power supply. When the instrument is in the first activation state, the heating element heats the first carving tool, and when the instrument is in a second activation state, the vibrator delivers vibrational energy to the second carving tool.

In another aspect, the invention is a kit. The kit includes an elongate tool handle having a power source coupled thereto, and a plurality of interchangeable dental tool working ends that can be mechanically and electrically coupled to the elongate handle.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows a plurality of known dental carving and placement instruments.

FIG. 2 shows/is a side view of dental carving and placement instrument according to an example embodiment of the present invention.

FIG. 3 is an electronic schematic drawing of one side of the dental instrument of FIG. 2 showing the relationship between the power source, controller/processor, switch, and heating element.

FIG. 4 shows a dental carving and placement instrument according to another example embodiment of the present invention.

FIG. 5 is an electronic schematic drawing of one side of the dental instrument of FIG. 4 showing the relationship between the power supply, controller/processor, switch, and vibrator.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

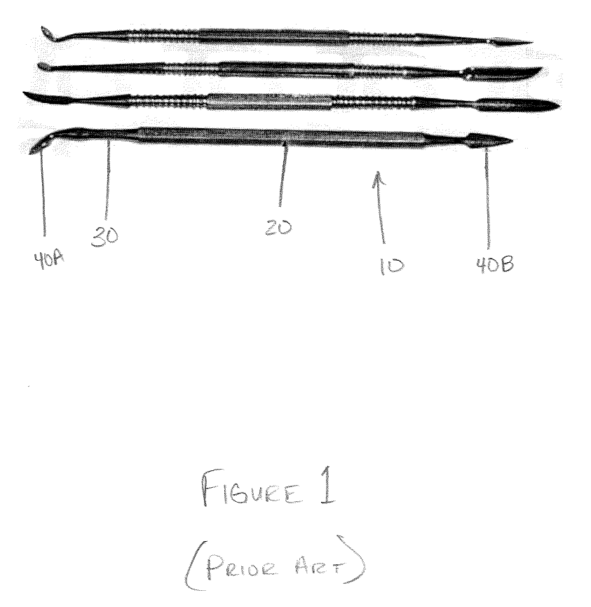

With reference now to the drawing figures, FIG. 1 depicts a plurality of known dental instruments 10 that are used for sculpting and delivering composite resin onto a tooth. Generally, known dental instruments 10 include a handle 20, shank 30, and at least one working end, or carving tool, 40. However, most dental instruments 10 include two complementary working ends 40A, 40B for the dentist's convenience, as seen in the drawing figure. The working ends 40 of the instruments 10 are used to place and sculpt composite resin onto a tooth being restored. There are numerous variations and types of working ends 40. Some of the working ends 40 are better suited for the placement of the resin, while others are used primarily for sculpting and finely adapting the same.

It has been found that it can be very difficult to accurately place and shape restorative composite resin using dental instruments such as those depicted in FIG. 1. Because the resin is very viscous and sticky, dentists often complain that it is very problematic to apply a small amount, or finely shape the resin. Additionally, it has been found that heating the composite resin before application decreases the resin's viscosity, allowing a dentist to more easily apply and shape the same. However, as soon as the resin is removed from the heat source, it rapidly cools and returns to a high viscosity state. Often this cooling takes place before the dentist can complete the tooling of the resin.

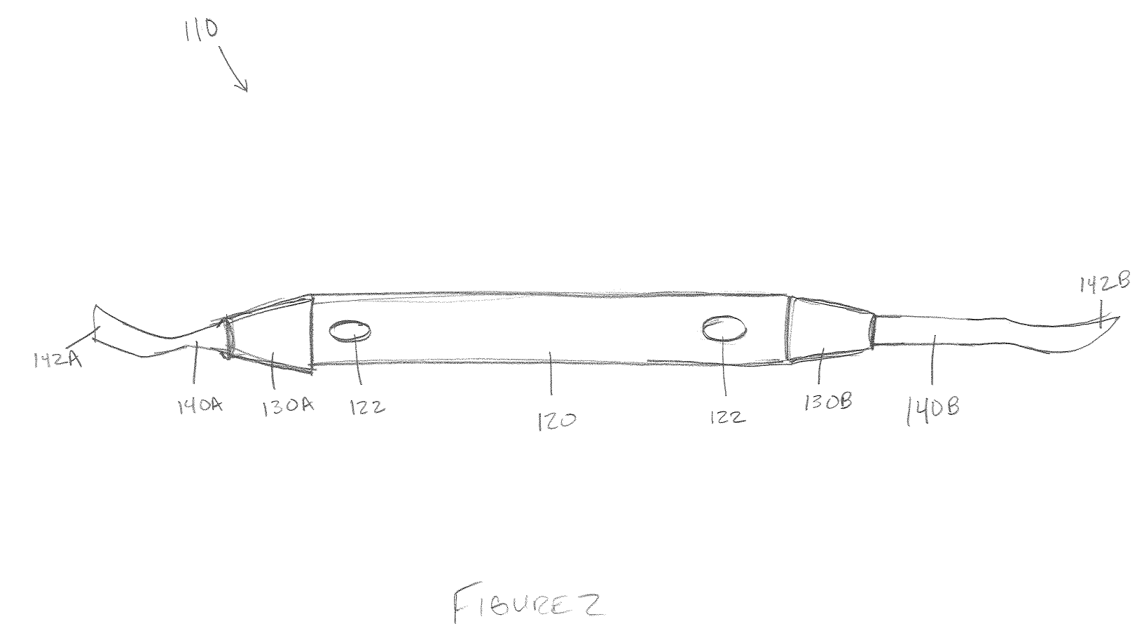

Therefore, one embodiment of the present invention comprises a dental instrument 110 having a heated tip, as seen in FIG. 2. Generally, the dental instrument 110 comprises an elongate handle 120, at least one insulated shank 130, and at least one working end/tool 140. The at least one working end 140 further comprises a heated tip 142. In example embodiments, the dental instrument 110 includes two insulated shanks 130A, 130B and two working ends 140A, 140B, with each shank and working end positioned at the distal and proximal ends of the handle 120 as shown in FIG. 2. In other embodiments, the working ends 140 of the instrument 110 are interchangeable, so that various shapes and styles of working ends can be used in conjunction with the instrument of the present invention. By placing the heated tip 142 of the instrument in contact with composite resin, a dentist is able to significantly lower the resin's viscosity. It has been found that once the viscosity of composite resin has been lowered, dentists are able to more easily work with and sculpt the resin.

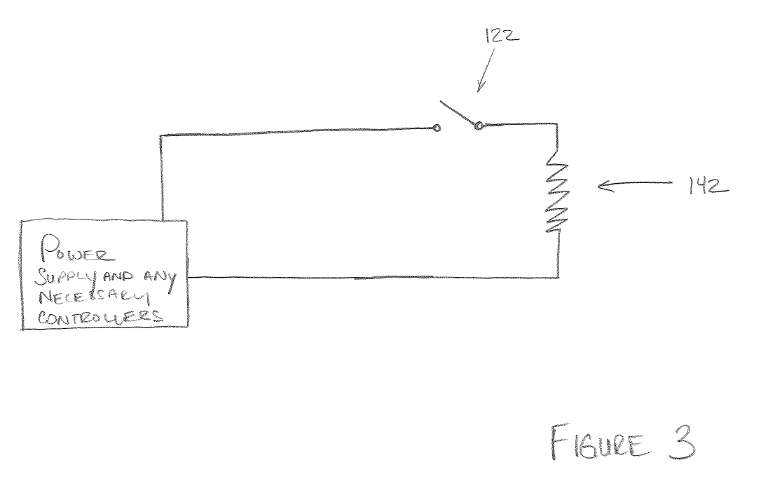

In example embodiments, the elongate handle 120 houses a power supply and controllers for powering the heating element in the tip 142 of the instrument 110, as seen schematically in FIG. 3. The power supply can comprise a traditional DC power source, such as alkaline type batteries, rechargeable batteries, lithium ion, nickel-cadmium, nickel-metal-hydride, button batteries, or any other suitable power source. In alternate embodiments, the power supply comprises rechargeable batteries that are inductively charged by placing the instrument 110 in a base recharger when the instrument is not in use. In other alternate embodiments, power to the instrument 110 is derived from AC power, such as plugging the instrument into an electrical outlet. The handle 120 can also comprise at least one button or switch 122 for user activation of the heated tip 142. In example embodiments, the handle length can range from two inches to six inches and most preferably about four inches. In other example embodiments, the handle can be much shorter or longer depending on the particular application. Additionally, the handle can be formed from metal, plastic, rubber, ceramics, or a combination thereof.

In further embodiments, the insulating shanks 130A, 130B and the working ends 140A, 140B are removably coupled to the distal and proximal ends of the handle 120 to provide for a wide range and variety of configurations of working ends to be used interchangeably in conjunction with the handle. In example embodiments, the shanks 130 and working ends 140 are integrated into one piece and can be screwed onto the handle 120 or coupled to the handle by other means, such as with clips, hooks, sockets, etc. Couplings can be used between the handle 120 and the interchangeable working ends 140, such that the couplings provide for mechanical and electrically conductive attachments between the two. In alternate embodiments, the shanks and working ends are detachable from each other, wherein the working ends screw or clip into a socket of the shank. In still other embodiments, the shank(s) and working end(s) are a unified component integrated to the distal end(s) of the handle 120. The shank 130 is preferably formed from an insulating material, such as a ceramic, polymer, or other insulating material, to prevent heat from the tip 142 to be lost via conduction to the handle 120. The working end 140 is preferably formed from metals, such as titanium, aluminum, stainless steel, other metals, or combinations thereof, so that heat is easily conducted across the working surface of the tip 142. Additionally, it has been found that metals are easy to clean and sanitize/sterilize. In alternate example embodiments, the working end 140 can comprise plastic or hard rubber.

The tip 142 of the working end 140 can be heated by a heating element, such as a resistive filament, micro-heating element, or other elements that can generate heat at the tip. In example embodiments, the heating element is embedded inside of the tip 142. It is preferred, but not necessary, that only the tip 142 of the working end 140 be directly heated, to save power and assure the user that only the tip will lower the viscosity of the composite resin. Additionally, in embodiments that utilize two working ends 140A, 140 B, it is preferred, but not necessary, that only one tip 142 be heated at a time. The tip 142 can be heated from ambient temperature to about 65 degrees Centigrade to adequately lower the viscosity of known dental composite resins. Alternative embodiments can be controlled to heat within higher or lower ranges of temperatures to accommodate composite resins having a different viscosity temperature relationship than those currently known. Those skilled in the art will understand how to configure thermostatic controllers of the instrument 110 such that the tip 142 is heated to a suitable temperature. Still other embodiments comprise adjustable temperature controllers to permit a user to regulate the tip 142 temperature. As previously mentioned, there are numerous shapes and sizes of working ends/tips that can be used with the present invention, such that a user can interchange working ends as desired or needed to accommodate a particular task. Of course, those skilled in the art will understand how to select an appropriate tip for a particular application. Additionally, a kit can be provided comprising various working ends, tips, power sources, chargers, and/or handles.

In operation, a user can easily apply and finely shape/adapt dental composite resin to a tooth using example embodiments of the present invention. A user activates the power source to heat the tip 142 of the working end 140 by manually manipulating the switch or button 122. As soon as the tip 142 is heated to the desired temperature, the user can begin to apply or shape the resin. When the tip 142 is placed into contact with the composite resin, the resin immediately surrounding the tip will begin to become more fluid and lose viscosity. In this state, the resin is more easily manipulated. As soon as the user has shaped or applied the resin in the desired manner, the tip 142 can be removed from the resin to permit the resin to return to its highly viscous state. Once the resin has been applied and properly shaped, the resin can undergo light curing to permanently fix in place the same.

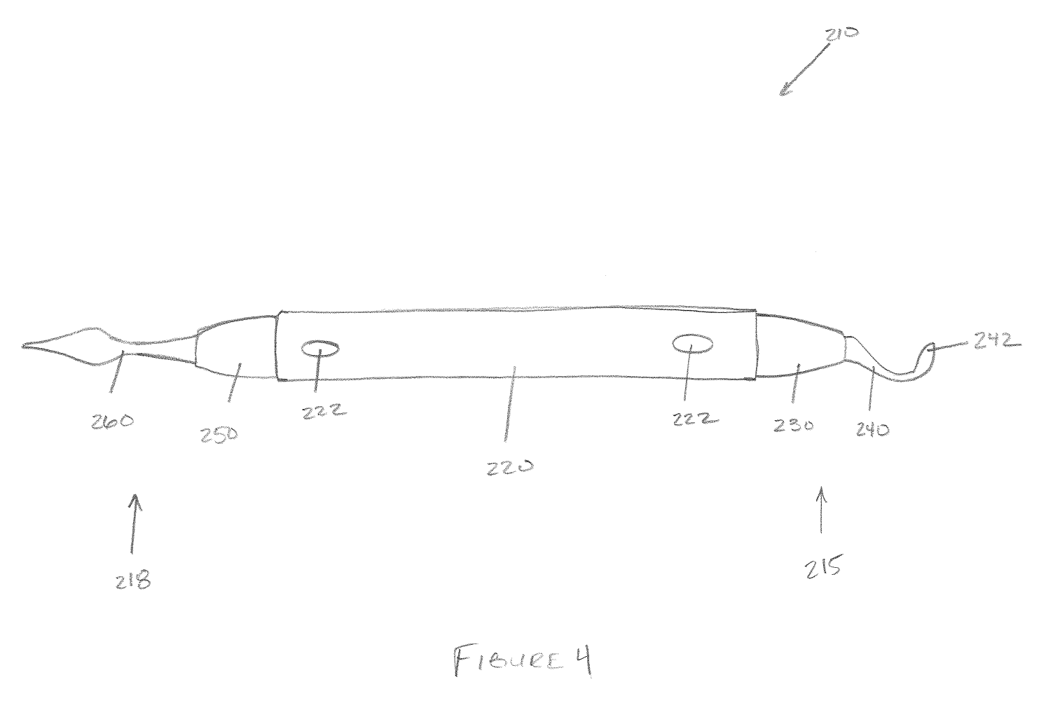

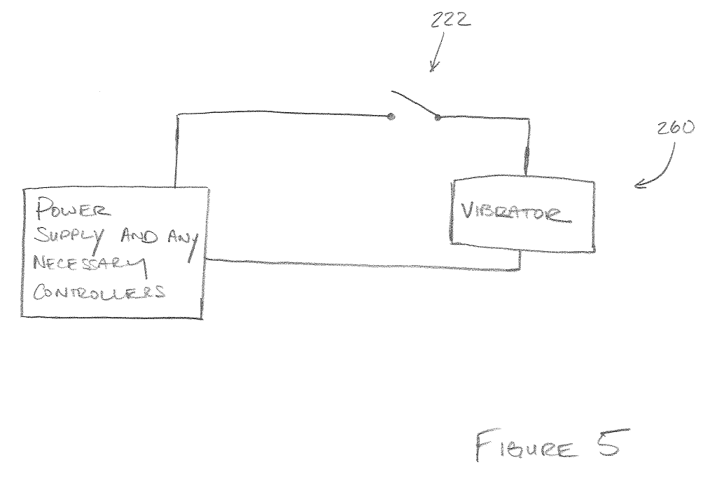

FIG. 4 depicts another example embodiment of the present invention, showing a double-sided dental instrument 210 for use in the placement and carving of dental composite resin. While a first side 215 of the dental instrument 210 generally comprises similar features to those embodiments discussed above (handle 220, activating switches 222, at least one insulating shank 230, and at least one working end/tool 240 having a heated tip 242), the second side 218 of the instrument comprises a working end 260 that is vibrated at subsonic, sonic, supersonic, or ultrasonic speeds. It has been found that such vibrational energy causes the resin to undergo sheer-induced thinning and lose viscosity. Generally, as depicted in FIG. 5, a power source and any necessary controllers are located within the handle 220 to drive a piezo-electric vibrator, or other means for producing vibration, in the shank 250. The vibrational energy from the shank 250 causes the second working end 260 to vibrate at high speeds. It is preferred, but not required, that the shank 250 further comprise a vibration damper to limit the amount of vibrations felt at the handle. In alternate embodiments, the dental instrument 210 includes vibrating ends 260 at both sides of the tool, one or both of which may or may not also be heated. In still other embodiments, the dental instrument 210 only has one working end, which produces vibrational energy rather than heat.

While the invention has been described with reference to preferred and example embodiments, it will be understood by those skilled in the art that a variety of modifications, additions and deletions are within the scope of the invention, as defined by the following claims.

What is claimed is:

1. A dental instrument for working with composite resin comprising:
an elongate handle; and
a tool located at a first end of the elongate handle, wherein the tool is adapted to manipulate composite resin and wherein the tool is heated.

2. The dental instrument of claim 1, wherein the tool comprises a heating element embedded therewithin.

3. The dental instrument of claim 2, wherein the elongate handle houses a power supply for energizing the heating element.

4. The dental instrument of claim 3, wherein the power supply is selected from alkaline type batteries, rechargeable batteries, lithium ion batteries, nickel-cadmium batteries, nickel-metal-hydride batteries, and button batteries.

5. The dental instrument of claim 3, wherein the handle further comprises at least one switch to activate the heating element.

6. The dental instrument of claim 1, further comprising a second tool located at a second end of the elongate handle.

7. The dental instrument of claim 1, wherein the tool is detachable from the handle such that it can be interchanged with a second tool.

8. The dental instrument of claim 1, further comprising a heat insulating shank positioned between the first end of the handle and the tool.

9. A double-sided dental carving instrument for modifying light curable composite resin, the instrument having an elongate handle, a first carving tool coupled to a first end of the handle, and a second carving tool coupled to a second end of the handle, the improvement comprising:
a power supply positioned within the handle; and
at least one heating element electrically coupled to the power supply for heating the first carving tool.

10. The dental carving instrument of the claim 9, wherein the instrument further comprises a second heating element electrically coupled to the power supply for heating the second carving tool.

11. The dental carving instrument of claim 9, wherein the first and second carving tools each have a tip, and wherein at least one of the tips is heated.

12. The dental carving instrument of claim 11, wherein the heating element is embedded within at least one of the tips of the carving tools.

13. The dental carving instrument of claim 9, wherein the power supply is selected from alkaline type batteries, rechargeable batteries, lithium ion batteries, nickel-cadmium batteries, nickel-metal-hydride batteries, and button batteries.

14. The dental carving instrument of claim 9, further comprising at least one switch to selectively activate the at least one heating element.

15. The dental carving instrument of claim 9, wherein the first carving tool has a first shape and the second carving tool has a second shape, and wherein the first and second carving tools are removably attached to the handle.

16. The dental carving instrument of claim 9, wherein at least the first carving tool comprises an insulating shank.

17. The dental carving instrument of claim 9, wherein the instrument further comprises a vibrator electrically coupled to the power supply for vibrating at least the second carving tool.

18. The dental carving instrument of claim 17, wherein the second carving tool comprises a vibration damper.

19. A dental instrument comprising:
an elongate handle defining a cavity therein, wherein the handle includes first and second ends;
a power supply housed within the cavity of the elongate handle;
a first carving tool coupled to the first end of the handle;
a second carving tool coupled to the second end of the handle;
a heating element electrically coupled to the power supply and embedded within the first carving tool; and
a vibrator electrically coupled to the power supply;
wherein in a first activation state, the heating element delivers heat to the first carving tool and in a second activation state, the vibrator delivers vibrational energy to the second carving tool.

20. A kit, comprising:
an elongate handle having a power source coupled thereto; and
a plurality of interchangeable dental tool working ends that can be mechanically and electrically coupled to the elongate handle.

21. The kit of claim 20, wherein a first dental tool working end comprises a heating element such that when coupled to the elongate handle and activated, the first dental tool working end emanates heat.

22. The kit of claim 21, wherein a second dental tool working end compromises circuitry for causing the tool to vibrate when coupled to the elongate handle and activated.
